(19) United States
(12) Patent Application Publication
(10) Pub. No.: US 2020/0133067 A1
(43) Pub. Date: Apr. 30, 2020

(54) DISPLAY SYSTEM WITH GEOMETRIC BACK LIGHT MODULE

(71) Applicant: GM GLOBAL TECHNOLOGY OPERATIONS LLC, Detroit, MI (US)

(72) Inventor: Richard Chiang, Sterling Heights, MI (US)

(73) Assignee: GM GLOBAL TECHNOLOGY OPERATIONS LLC, Detroit, MI (US)

(21) Appl. No.: 16/169,265

(22) Filed: Oct. 24, 2018

(51) Int. Cl. G02F 1/1335; G02F 1/1368; B60K 35/00

(52) U.S. Cl. CPC G02F 1/133603; B60K 35/00; G02F 1/1368; G02F 1/133528

(57) ABSTRACT

A display system with a geometric backlight module is provided. The display system includes a screen configured to display images. A backlight module is disposed behind the screen. The backlight module includes a geometric structure with a number of cells, each cell defined by a number of side walls, wherein the number is greater than four. A light source is disposed in each cell. The light sources are configured to illuminate the screen independently from one another.

### INTRODUCTION

The present disclosure generally relates to visual displays, and more particularly relates to liquid-crystal-displays that include geometric back light modules for improved image production.

A common type of visual display device for use with instruments, computers, televisions and other applications employs liquid-crystal-display (LCD) technology. LCD devices use liquid crystals to modulate light and produce images. The liquid crystals require a light source to produce images. The light source may be any of a number of different types of light emitting devices. A common way to apply the light to the display is by edge-lighting, where the light source is at the edge of a display panel. A waveguide plate guides the light from the edge of the display panel and distributes it across the screen. Because the light source is at the edge of the screen, providing uniformity in light quality across the screen is difficult. In other words, some areas may be too bright and other areas may be too dark, for example when the ambient light is low or when areas of the screen are intended to be dark.

With a backlight LCD, the light source is positioned at the back of the screen that acts as a uniform backlight, although the contrast ratio is limited. An electroluminescent panel may be used to provide even backlighting, however they typically do not provide local dimming. Backlighting with local dimming has been proposed to improve the contrast ratio. Local dimming however is limited in its ability to provide sharp images of irregular shapes and tends to produce discernable halos when the ambient light is low, or a very dark area of an image is adjacent a brighter area.

Accordingly, it is desirable to provide improved image production in visual displays. Other desirable features and characteristics of the present invention will become apparent from the subsequent detailed description and the appended claims, taken in conjunction with the accompanying drawings and the foregoing technical field and background.

### SUMMARY

In a number of embodiments, a display system includes a geometric backlight module. The display system includes a screen configured to display images. A backlight module is disposed behind the screen. The backlight module includes a geometric structure with a number of cells, each cell defined by a number of side walls, wherein the number is greater than four. A light source is disposed in each cell. The light sources are configured to illuminate the screen independently from one another.

In additional embodiments, the number of side walls is six.

In additional embodiments, the backlight module includes a backwall from which each of the side walls extends toward the screen.

In additional embodiments, one of the light sources is positioned in each of the cells on the backwall.

In additional embodiments, each light source is centered within it respective cell.

In additional embodiments, each light source includes a light emitting diode.

In additional embodiments, each of the light emitting diodes is configured to illuminate only when it lies directly behind a desired image on the screen.

In additional embodiments, the display system comprises a thin film transistor liquid crystal display, with a thin-film-transistor array disposed between the backlight module and the screen.

In additional embodiments, a polarizer is disposed between the backlight module and the thin-film-transistor array.

In additional embodiments, a second polarizer is disposed on an opposite side of the thin-film-transistor array from the backlight module.

In a number of other embodiments, a display system includes a screen configured to display images for viewing from a viewing side. A backlight module is disposed behind the screen and is configured to illuminate the images. The backlight module includes a number of cells extending across the backlight module, each cell defined by a backwall and six side walls, each extending from the backwall toward the viewing side. A light source is disposed in each cell. The light sources are configured to illuminate the screen independently from one another for local dimming, wherein only the cells located directly behind the images are illuminated.

In additional embodiments, one of the light sources is positioned in each of the cells on the backwall.

In additional embodiments, each light source is centered within it respective cell.

In additional embodiments, each light source comprises a light emitting diode.

In additional embodiments, the display system comprises a thin film transistor liquid crystal display, with a thin-film-transistor array disposed between the backlight module and the screen.

In additional embodiments, a polarizer is disposed between the backlight module and the thin-film-transistor array.

In additional embodiments, a second polarizer is disposed on an opposite side of the thin-film-transistor array from the backlight module.

In additional embodiments, the thin-film-transistor array is disposed on a substrate.

In additional embodiments, the side walls are configured to contain and direct the light toward the viewing side.

In a number of other embodiments, a display system includes a screen configured to display images for viewing from a viewing side. A backlight module is disposed behind the screen and is configured to illuminate the images. The backlight module includes a number of cells extending across the backlight module, each cell defined by a backwall and six side walls. Each side wall extends from the backwall toward the viewing side. Each cell has a hexagonal shape and the side walls are configured to contain and direct the light toward the viewing side. A light source is disposed in each cell. The light sources are configured to illuminate the screen independently from one another for local dimming, wherein only the cells located directly behind the images are illuminated.

### BRIEF DESCRIPTION OF THE DRAWINGS

The exemplary embodiments will hereinafter be described in conjunction with the following drawing figures, wherein like numerals denote like elements, and wherein:

FIG. 1 is an illustration of a vehicle with an instrument panel and instrument cluster in accordance with various embodiments;

FIG. 2 is a graphic illustration of an instrument panel and liquid-crystal-display in accordance with various embodiments;

FIG. 3 is a sectional, side view of the liquid-crystal display of FIG. 2, in accordance with various embodiments;

FIG. 4 is a schematic isometric illustration of a backlight module of the liquid-crystal display of FIG. 2, in accordance with various embodiments;

FIG. 5 is a diagram a schematic illustration of a single cell of the backlight module of FIG. 4, in accordance with various embodiments;

FIG. 6 is a diagram representing a portion of the backlight module of FIG. 5, in accordance with various embodiments;

FIG. 7 is a diagram of a single light-emitting-diode area of a backlight module according to a comparative structure;

FIG. 8 is a diagram representing a single light-emitting-diode area of the backlight module of FIG. 5, in accordance with various embodiments;

FIG. 9 is a diagram representing a shadow area of a single light-emitting-diode area of a backlight module according to a comparative structure;

FIG. 10 is a diagram representing a shadow area of a single light-emitting-diode area of the backlight module of FIG. 5, in accordance with various embodiments; and

FIG. 11 is a diagram representing a portion of the backlight module of FIG. 5, in accordance with various embodiments in comparison with a square celled backlight module.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

In one or more exemplary embodiments related to display systems and as described herein, a geometric backlight module provides desirable luminance and uniformity characteristics. For example, sharp images are produced with reduced halo effects at reduced power consumption. It has been discovered that uniformity issues with irregular shapes and halo effects are a result of limitations in backlighting. It has also been discovered that a geometric backlight module, such as with hexagonal cells, produces unexpectedly desirable results as further described below. In certain embodiments as described further below, a display system includes a screen configured to display images. A backlight module is disposed behind the screen. The backlight module includes a geometric structure with a number of cells, each cell defined by a number of side walls, wherein the number is greater than four. A light source is disposed in each cell. The light sources are configured to illuminate the screen independently from one another. While embodiments describe herein may be related to a vehicle, the disclosure is not limited to vehicle applications, but rather is applicable to any application where improved image display is desired.

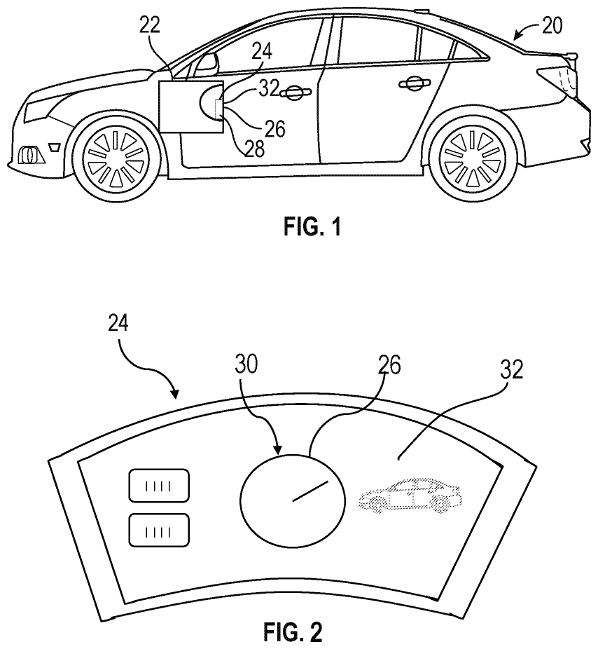

Referring to FIG. 1, a vehicle 20 includes an instrument panel 22 in which is disposed an instrument cluster 24. The instrument cluster 24 includes a variety of instrument elements, one of which is indicated as instrument 26. The instrument 26 provides an indication of information such as of an associated data relating to the operation of the vehicle 20, such as speed, engine speed, coolant temperature, oil pressure, battery charge status and fuel quantity, without limitation to various other instruments providing any number of indications. In the current embodiment, the instrument 26 includes a display in the form of a LCD device 28. The LCD device 28 includes a screen 32 configured to display textual and graphic information of various forms, including images and including in static and dynamic forms, and an under a variety of ambient lighting conditions. Clear images and indications are required so that the vehicle operator is able to readily perceive the information quickly and without eye strain.

Referring to FIG. 2, the instrument cluster 24 includes the instrument 26, which in this embodiment is displaying a speedometer 30 to provide an indication of the speed of the vehicle 20. In this embodiment, the speedometer 30 is displayed by the LCD device 28, which also concurrently displays other information. The LCD device 28 may also provide alternative information at the same location of the screen 32 as the speedometer 30. In the case of the speedometer 30, the outline is generally circular in shape with speed graduations provided around the circular shape. Delivering the desired circular and irregular shapes with good contrast and free of halos is challenging.

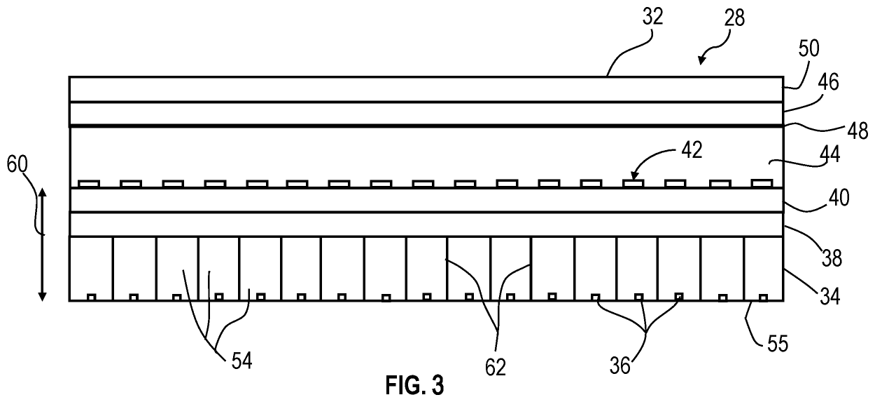

As shown schematically in FIG. 3, the LCD device 28 is a back-lit device with local dimming. The light source is integrated in, and distributed across, the backlight module 34 and may include any of a number of light sources and in the current embodiment, the light source includes LEDs 36. In general, the LCD device 28 includes the backlight module 34 a polarizer 38, a thin-film-transistor (TFT) array substrate 40, a TFT array 42 liquid crystal layer 44, a color filter substrate 46, color filter 48 and a polarizer 50. A viewing side 52 of the display is located in front of the screen 32. Other typical components are omitted for simplicity.

When the LCD device 28 is in operation, selectively powered LEDs 36 emit light that travels through the polarizer 38, which allows light directed in a certain orientation, for example the vertical wavelength, to pass through while blocking other orientations. Only the LEDs 36 directly behind the desired image are illuminated, while the others remain off. The polarized light passes through the TFT array substrate 40, which in the current embodiment is a glass layer. The light then enters the liquid crystal layer 44. Liquid crystals in the liquid crystal layer are manipulated by applying power to the TFT array 42. As a result, the liquid crystals are used to variably block the light creating the desired image. The passing light travels through the color filter substrate 46, which in this embodiment is glass. The color filter 48 allows a range of wavelengths appropriate to the selected color to pass into the color filter substrate 46. The light then passes through the polarizer and for example, only horizontal wavelengths are allowed to pass through while other orientations are blocked. As a result, the desired image is displayed for the viewer. Additional details of the LCD device are omitted for simplicity. For example, indium tin oxide electrodes (not shown), may be included between the TFT array substrate 40 and the color filter substrate 46.

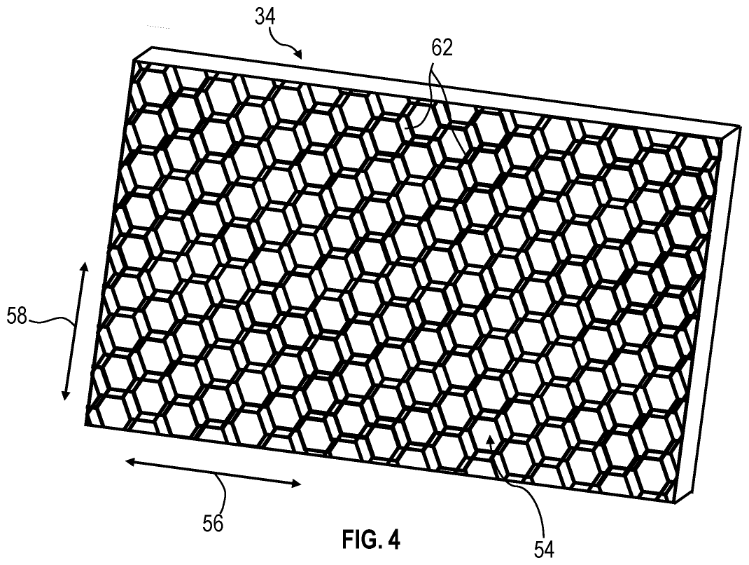

The backlight module 34 includes a matrix of compartments referred to as cells 54, which extend from the module base 55. The cells 54 are arrayed across the backlight module 34 in both lateral (side-to side) directions 56, 58 of the LCD device 28 as shown in FIG. 4 to which reference is additionally directed. The cells 54 cover the entire area of the backlight module 34 to the extent practical providing a geometric character. In certain embodiments, due to the shape of the cells 54, a border around the LCD device 28 may not be entirely covered by functional cells and therefore may be covered, such as by a bezel (not shown). In a number of embodiments, the cells 54 each include more than four side walls. In the current embodiment, the cells 54 are hexagonal in shape in the plane defined by the lateral directions 56, 58 and the hexagonal shape extends completely along the depth (fore-aft) direction 60 of the LCD device 28. The cells 54 are separated from one another by a geometric wall structure 62 forming a lattice honeycomb-like structure.

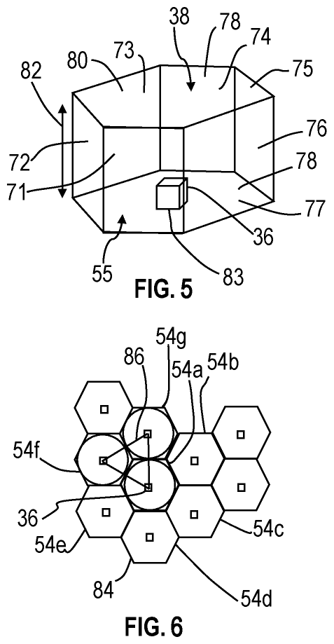

As shown in FIG. 5, each cell 54 has a total of six side walls in this embodiment, designated as walls 71-76, each of which is part of the wall structure 62. The walls 71-76 define a planar hexagonal shaped area 78 at the module base 55. In addition, the walls 71-76 define a planar hexagonal shaped area 80 at the polarizer 38. The walls 71-76 are formed of an opaque material, such as a polymer, metal, composite or other material and are symmetric The walls 71-76 are configured to contain and direct light from the LED 36 forward. Each wall 71-76 is identical to the others and the group is oriented to form the desired geometric design, in this embodiment the hexagonal design. The geometric hexagonal cell 54 design has a three-dimensional structure with a height 82 extending from the backwall 77, and a size that will vary depending on different forms of displays. Each geometric hexagonal cell 54 has a light source, in this embodiment the LED 36, and each LED 36 is controlled independently as an independently illuminating light source. Each LED 36 is positioned in the center 83 of it respective cell 54 for good light distribution within the cell 54. Each cell 54, other than those at an edge of the display (LCD device 28), adjoins six others.

Referring to FIG. 6, a portion of the backlight module 34 is illustrated. One cell 54a, is surrounded by six adjacent cells 54b-54g. Each of the cells 54a-54g has a LED 36 on the backwall 77. When a line or image desired on the display (in this embodiment LCD device 28), passes over a given cell 54, the LED 36 in that cell 54 is illuminated. With hexagonal cells 54, the relation between the LEDs 36 in the cells 54a-54g creates a hexagonal shape 84. One sector of the hexagonal shape 84 defines a triangle 86. The structure of the geometric hexagonal cells 54 and LEDs 36, reduces image halo size, and power consumption is lower than with typical displays.

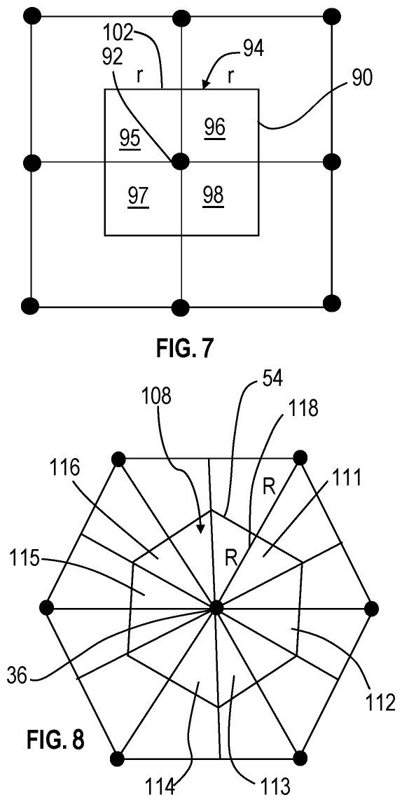

The benefit of using hexagonal cells 54 is demonstrated through FIGS. 7-10 to which reference is directed. FIG. 7 represents a square shaped cell 90 with a center LED 92 and its adjacent eight LEDs. The cell 90 has a luminance area 94 comprised of sub-areas 95-98, which are illuminated by the single LED 92. The sub-areas 95-98 are each square and have sides 102, 104 with a length r. The luminance area 94 has an area A₉₄ equal to 4r². FIG. 10 represents the shadow area of the square shaped cell 90. In this case, the distance between adjacent LEDs 92 is 2r and the shadow area S₉₄ is equal to 4r²−πr².

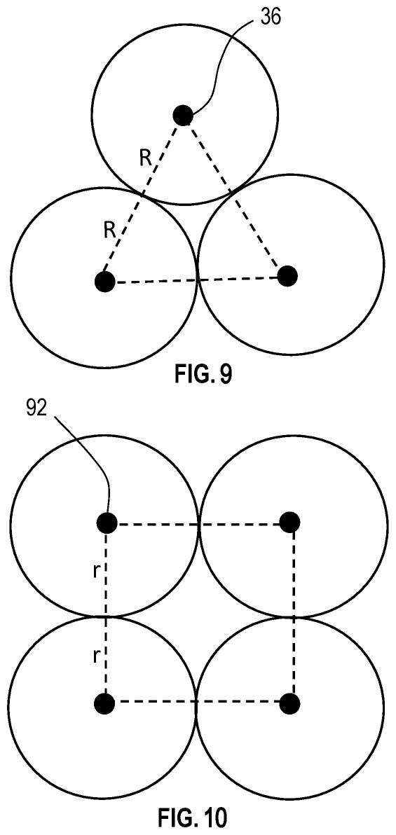

FIG. 8 represents a hexagonal shaped cell 54 with a center LED 36 and its adjacent six LEDs. The cell 54 has a luminance area 108 comprised of sub-areas 111-116, which are illuminated by the single LED 36. The sub-areas 111-116 are each triangular and have sides 118 with a length R. The luminance area 108, which is the sum of the sub-areas 111-116, has an area A₁₀₈ equal to 2\sqrt{3} R². FIG. 9 represents the shadow area of the hexagonal shaped cell 54. In this case, the distance between adjacent LEDs 36 is 2R and the shadow area S₁₀₈ is equal to 2\sqrt{3}−½(πR²). For a single LED 36, 92, the exposed area energy is the same so that A₉₄=A₁₀₈. As a result, 4r²=2\sqrt{3} R², and S₉₄=4.6S₁₀₈. This means that the shadow area S₉₄ for the square cell 90 is 4.6 times as large as the shadow area S₁₀₈ for the hexagonal cell 54. Accordingly, when the LED 36 in the hexagonal cell 54 is illuminated, it throws a shadow over an area A₁₀₈ that is much smaller than the area A₉₄ over which the LED 92 in the square cell 90. The result is a reduced halo size for illuminated LEDs 36 in a backlight module 34 with hexagonal shaped cells 54.

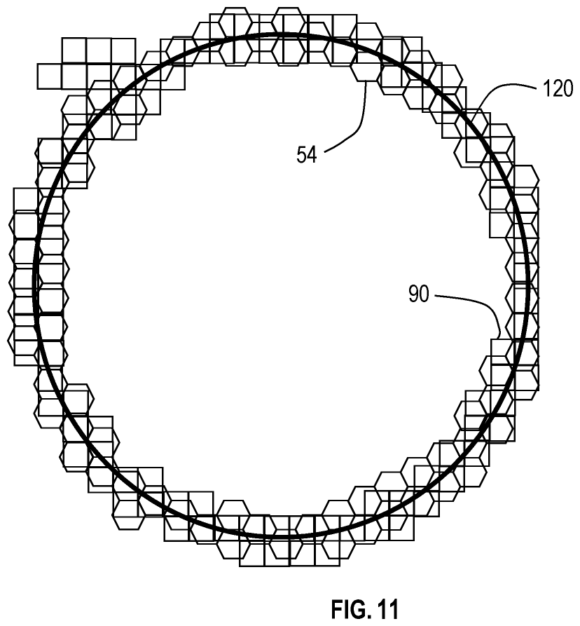

FIG. 11 demonstrates the benefit of a hexagonal shaped cell 54 structure for backlight module 34 as compared to a square shaped cell 90 structure. In this example a circle 120 represents an image displayed on the LCD device 28 for example, as used in a speedometer. In this example, the circle has a diameter of 100 millimeters. The cells 54, 90 necessary to illuminate the image (circle 120) are illuminated via their respective LEDs. To display the circle 120, a total of 110 square cells 90 require illumination, whereas a total of only 84 hexagonal cells require illumination. The savings is approximately 20% in the number of LEDs 36 illuminated resulting in power savings and additional halo size reduction. The benefit of using a cell structure with a shape having more than four sides is demonstrated. For example, a cell shape that is hexagonal, octagonal, etc. is beneficial in reducing halo effect and power consumption. Reduced halo results in improved image production with improved contrast.

Through the above described display systems include geometric backlight modules having cells with more than four sides. The display system mitigates any otherwise experienced uneven halo effect and reduces the power consumption.

It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A display system comprising:
a screen configured to display images;
a backlight module disposed behind the screen, the backlight module including a backwall and a geometric structure with a number of cells, each cell defined by a number of side walls, wherein the number is greater than four, and a light source in each cell on the backwall, the light sources configured to illuminate the screen independently from one another;
a polarizer disposed between the backlight module and the screen; and
a thin-film-transistor array substrate disposed between the backlight module and the screen,
wherein the sides walls are opaque and extend from the backwall to at least one of the polarizer or the thin-film-transistor array substrate.

2. The display system of claim 1, wherein the number of side walls is six.

3. (canceled)

4. (canceled)

5. The display system of claim 4, wherein each light source is centered within its respective cell.

6. The display system of claim 1, wherein each light source comprises a light emitting diode.

7. The display system of claim 6, wherein each of the light emitting diodes is configured to illuminate only when it lies directly behind a desired image on the screen.

8. (canceled)

9. (canceled)

10. The display system of claim 1, comprising a second polarizer disposed on an opposite side of the thin-film-transistor array from the backlight module.

11. A display system comprising:
a screen configured to display images for viewing from a viewing side;
a backlight module disposed behind the screen and configured to illuminate the images, the backlight module including:
a number of cells extending across the backlight module, each cell defined by a backwall and six side walls, each extending from the backwall toward the viewing side; and
a light source in each cell, the light sources configured to illuminate the screen independently from one another for local dimming, wherein only the cells located directly behind the images are illuminated;
a thin-film-transistor array disposed between the backlight module and the screen; and
a liquid crystal layer disposed between the thin-film-transistor array and the screen.

12. The display system of claim 11, wherein one of the light sources is positioned in each of the cells on the backwall.

13. The display system of claim 12, wherein each light source is centered within its respective cell.

14. The display system of claim 11, wherein each light source comprises a light emitting diode.

15. The display system of claim 11, wherein each cell has a shadow area equal to 2\sqrt{3}−½(πR²), where R is half a distance between adjacent light sources.

16. The display system of claim 15, comprising a polarizer disposed between the backlight module and the thin-film-transistor array.

17. The display system of claim 16, comprising a second polarizer disposed on an opposite side of the thin-film-transistor array from the backlight module.

18. The display system of claim 17, comprising a substrate on which the thin-film-transistor array is disposed.

19. The display system of claim 11, wherein the side walls are configured to contain and direct the light toward the viewing side.

20. A display system comprising:
a screen configured to display images for viewing from a viewing side;
a backlight module disposed behind the screen and configured to illuminate the images, the backlight module including:
a number of cells extending across the backlight module, each cell defined by a backwall and six side walls, each wall formed of an opaque material and extending from the backwall toward the viewing side, wherein each cell has a hexagonal shape and the side walls are configured to contain and direct light toward the viewing side; and
a light source in each cell, the light sources configured to illuminate the screen independently from one another for local dimming, wherein only the cells located directly behind the images are illuminated;
a thin-film-transistor array disposed between the screen and the backlight module; and
a polarizer disposed between the backlight module and the screen,
wherein the cells each extend from the backwall to one of the thin-film-transistor array or the polarizer,
wherein the walls of each cell are opaque and define a first planar hexagonal shaped area at the base and define a second planar hexagonal shaped area at the thin-film-transistor array or the polarizer.
